(19) United States
(12) Patent Application Publication
(10) Pub. No.: US 2026/0087715 A1
(43) Pub. Date: Mar. 26, 2026

(54) AUTOMATIC ANIMATION OF VISUAL CONTENT

(71) Applicant: Adobe Inc., San Jose, CA (US)

(72) Inventors: Cuong NGUYEN, San Francisco, CA (US); Wilmot Wei-Mau LI, Seattle, WA (US); Vickramaditya DHAWAL, Bengaluru (IN); Stephen Joseph DIVERDI, Berkeley, CA (US); Seth WALKER, Oakland, CA (US); Nicole LAM, New York, NY (US); Matthew FISHER, Burlingame, CA (US); Lily KHONG, Hayward, CA (US); Kurt HESTON, Hayward, CA (US); Kathryn NASH, Los Angeles, CA (US); Joaquin Cruz BLAS, JR., Pacifica, CA (US); Jacob GOLDSTEIN, Alameda, CA (US); Christina COX, Sydney (AU); Anirudh SASIKUMAR, Pleasanton, CA (US); Romero ALVES, Nevada City, CA (US)

(21) Appl. No.: 19/004,073

(22) Filed: Dec. 27, 2024

Related U.S. Application Data
(60) Provisional application No. 63/699,643, filed on Sep. 26, 2024.

(51) Int. Cl. G06T 13/80

(52) U.S. Cl. CPC G06T 13/80

(57) ABSTRACT

Various disclosed embodiments are directed to the automatic animation of visual content. Specifically, some embodiments first receiving a design document. Some embodiments then generate a rendered image of the design document. Some embodiments then generate a mask that indicates one or more regions of visual importance in the image. Some embodiments further generate, from the design document, a scene graph. Some embodiments detect one or more hero elements based at least in part on the mask, the filtering of the scene graph, clustering, and/or one or more hero element rules. Some embodiments additionally or alternatively determine one or more animation rules based on saliency data and/or hero element detection in order to generate an animation sequence or output.

### CROSS-REFERENCE TO RELATED APPLICATIONS

This application claims priority to U.S. Provisional Patent Application No. 63/699,643 entitled “AUTO-ANIMATE EXPRESS DESIGN DOCUMENTS USING SALIENCY DETECTION AND HEURISTIC PROGRAMMING,” filed Sep. 26, 2024, which is incorporated by reference in its entirety.

### BACKGROUND

Existing media design technologies allow users to create a variety of visual content, including digital posters, digital greeting cards, slides, infographics, or the like. These tools offer useful features for crafting static designs with a range of templates, design elements, and customization options, making it easier for users to produce visually appealing graphics. However, significant technical challenges arise in the transformation of these static designs into engaging animations. The process of animating static content typically requires manual adjustments, in-depth animating knowledge of animation techniques, significant time investment, and excessive computing resource consumption, among other challenges.

### SUMMARY

One or more embodiments are directed to the automatic animation of visual content. Specifically, for instance, some embodiments first receive a design document (e.g., a digital brochure, a digital poster, a web page mockup, or a slide show presentation). Some embodiments then generate a rendered image of the design document. For example, some embodiments combine all the visual elements and layers from the design document into a single, flattened image that shows the final appearance as indicated in the design document. Some embodiments then generate a mask that indicates one or more regions of visual importance in the image. For example, some embodiments generate a saliency mask by providing a representation of the rendered image as input to a saliency model, where the saliency mask indicates one or more regions that are likely to attract human attention.

Some embodiments further generate, from the design document, a scene graph. A scene graph represents each element in the design document in a hierarchical structure where each node in the scene graph corresponds to an element or group of elements in the design document. For instance, a scene graph may organize elements in a tree-like hierarchy, where each node represents an element (or object) in the scene. Some embodiments detect one or more hero elements based at least in part on the mask, the filtering of the scene graph, clustering, and/or one or more hero element rules. A hero element is a key or visually prominent component within a design document or scene that is useful for the overall message, user interaction, or visual hierarchy. Hero elements typically attract the most attention and are emphasized in animations or visual treatments due to their importance. These elements may include main headlines, primary images, and/or key calls to action that are central to the design's purpose. For example, some embodiments overlay the saliency data of a saliency mask onto the scene graph to determine which specific elements correspond to the high-saliency areas identified in the rendered image.

Some embodiments additionally or alternatively determine one or more animation rules based on saliency data and/or hero element detection. For example, a saliency map might show high saliency for the headline text and product image, moderate saliency for the call-to-action button, and low saliency for decorative snowflakes. Based on the saliency data and/or elements being detected as hero elements, various embodiments use heuristic animation rules to decide how to animate each element. For example, a rule may be to “apply dynamic animations to high-saliency elements to immediately capture viewer attention.” Since the headline text and product image have high saliency, the rule dictates using dynamic animations for these elements. Animation is the process of creating motion or the illusion of motion and change (e.g., by displaying a series of still images or frames in succession). In the context of digital design, animation involves applying movement, transitions, or effects to visual elements (such as text, images, or shapes) to make them appear dynamic or interactive. For example, an image of a ball that appears to bounce up and down when a sequence of frames showing the ball at different positions is played quickly in succession is an animation. An animation sequence is a specific series of frames or steps that define the movement or change of visual elements over time within an animation.

Various embodiments of the present disclosure have various technical effects and improvements over existing media design technologies. For example, some technical effects include improved user interfaces, improved user experiences (e.g., by not requiring in-depth animation knowledge), and reduced computing resource consumption (e.g., reduced computer input/output (I/O), reduced memory consumption, etc.), as described in more detail herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present invention is described in detail below with reference to the attached drawing figures, wherein:

FIG. 1 block diagram of an example computing system architecture suitable for implementing some embodiments of the disclosure;

FIG. 2 illustrates an example pipeline for generating an output animation, according to some embodiments;

FIG. 3 illustrates an example pipeline of a saliency model, according to some embodiments;

FIG. 4A is a screenshot of a user interface page illustrating a static design document before a request is made to generate an animation, according to some embodiments;

FIG. 4B is a screenshot of the user interface page of FIG. 4A, illustrating a beginning step of a “Waterfall” animation style in response to a user request to generate a corresponding animation sequence, according to some embodiments;

FIG. 4C is a screenshot of the user interface page of FIG. 4A, illustrating an intermediate step of the “Waterfall” animation style sequence initiated in FIG. 4B, according to some embodiments;

FIG. 4D is a screenshot of the user interface page of FIG. 4A, illustrating a last-in-time step of the “Waterfall” animation style sequence continued from FIG. 4C, according to some embodiments;

FIG. 5 is a flow diagram of an example process for filtering a scene graph, according to some embodiments;

FIG. 6 is a flow diagram of an example process for detecting one or more groups of hero elements, according to some embodiments;

FIG. 7 is a flow diagram of an example process for training a machine learning model to generate a saliency mask, according to some embodiments;

FIG. 8 is a flow diagram of an example process for generating an animation sequence, according to some embodiments;

FIG. 9 is an example computer environment in which aspects of the present disclosure are employed, according to some embodiments; and

FIG. 10 is a block diagram of a computing device in which aspects of the present disclosure employ, according to some embodiments.

### DETAILED DESCRIPTION

### Overview

As described above, the process of animating static content has technical challenges by typically requiring manual adjustments, in-depth animating knowledge of animation techniques, significant time investment, and excessive computing resource consumption. For example, with respect to manual adjustments, excessive drilling is typically required at a user interface. When animating static content, users often need to make numerous manual adjustments, such as setting keyframes, adjusting timing, or modifying the properties of individual elements (e.g., position, opacity, rotation). Each of these actions typically require navigating through several menus, panels, or layers in the software, which can be cumbersome and time-consuming. For instance, a user might have to select an object, then drill down into its properties to adjust the timing of an animation, and repeat this process for every element on the page, leading to a repetitive and labor-intensive workflow.

Further, these technologies require in-depth knowledge of animation techniques. Animation techniques involve principles such as timing, easing, motion paths, and layering, which dictate how an object moves, changes, or interacts over time. To create smooth and visually appealing animations, users must typically understand these principles and how to apply them effectively. This often requires specialized knowledge that goes beyond basic design skills. For example, a user needs to know how to set appropriate keyframes to control the start and end points of an animation and use easing functions to create natural motion (e.g., an object accelerating or decelerating smoothly). Without this knowledge, animations might look jerky, unprofessional, or fail to convey the intended message.

Even with software that provides animation capabilities, manually animating each element can be a slow and labor-intensive process, especially for complex designs with multiple animated components. Creating animations also typically involves a lot of detailed work, including designing motion paths, setting keyframes, and fine-tuning animations to ensure they look right. For instance, a user animating a slide with multiple text blocks and images might spend hours setting up individual animations for each element, adjusting timings to synchronize animations, and previewing the results repeatedly to ensure everything looks cohesive, which is too arduous for users.

Existing technologies are also associated with increased computing resource consumption, such as increased input/output (I/O). I/O operations refer to the reading and writing of data to and from storage devices or the rendering of animations on-screen. Excessive I/O operations create wear and tear on storage devices (e.g., disk) due to the excessive mechanical movements. As described above, users typically manually navigate through various panels, layers, and properties in the user interface to set up animations. Each click, drag, or adjustment requires the software to read data from storage (input) and update the interface (output). For instance, when a user adjusts the position of an object frame-by-frame, the software must load the current frame's data, apply the changes, and then save or render the new state. This cycle of loading, modifying, and saving repeatedly increases I/O operations, thereby placing unnecessary wear and tear on storage components. Further, every time a user modifies a parameter (like position, scale, rotation, or opacity), the software must read the current state of the element, process the change, and write the updated state back to memory or disk. This is especially true for applications that save changes frequently to prevent data loss. For instance, if a user is animating a complex scene with multiple keyframes, every adjustment—whether adding, deleting, or modifying keyframes—results in multiple excessive read/write operations. The system reads the current data, updates it with new keyframe information, and writes it back to storage.

Existing technologies are also associated with increased memory consumption. When a user interacts with a complex animation software interface, especially by drilling down into multiple layers and properties, the software needs to load all the relevant data for each element. This includes metadata, visual properties, animation states, and more. All this information is typically stored in RAM for quick access, increasing memory consumption. Many animation tools maintain a history of user actions to support undo/redo functionality. Each user input that changes the state of the project is recorded, which requires memory. As users make numerous adjustments (excessive drilling), the memory required to store these states increases, especially for complex projects with multiple layers and elements.

Embodiments of the present disclosure provide one or more technical solutions to one or more of these technical problems, as described herein. Various aspects are directed to the automatic animation of an image. Specifically, for instance, some embodiments first receiving a design document. A design document is a file created in graphic design or layout software. Digital design documents contain structured visual elements and are used to create a variety of visual content. For example, a design document can include a digital brochure, a digital poster, a digital business card, a web page mockup, a social media graphic, an infographic, a slide show presentation, a UI design, a digital logo, a branding guide, or a digital magazine layout.

Some embodiments then generate a rendered image of the design document. For example, a Painter's algorithm can be used to combine all the visual elements and layers from the design document into a single, flattened image that shows the final appearance as indicated in the design document. Some embodiments then generate a mask that indicates one or more regions of visual importance in the image. For example, some embodiments generate a saliency mask by providing a representation of the rendered image as input to a saliency model, where the saliency mask indicates one or more regions that are likely to attract human attention.

Some embodiments further generate, from the design document, a scene graph. A scene graph represents each element in the design document in a hierarchical structure where each node in the scene graph corresponds to an element or group of elements in the design document. For instance, a scene graph may organizes elements in a tree-like hierarchy, where each node represents an element (or object) in the scene. Nodes can have parent-child relationships, indicating how elements are grouped and positioned relative to each other. Some embodiments filter the scene graph by selecting or discarding specific elements from the scene graph according to predefined criteria. For example, the location of an element in the design could be a criterion. Elements placed in prominent positions (like the center or top of the design) might be prioritized, while those in less noticeable areas (like the corners or edges) could be discarded.

Some embodiments detect one or more hero elements based at least in part on the mask, the filtering of the scene graph, clustering, and/or one or more hero element rules. The one or more hero elements indicate one or more regions of visual importance. For example, some embodiments overlay the saliency data of a saliency mask onto the scene graph to determine which specific elements correspond to the high-saliency areas identified in the rendered image. Various embodiments additionally apply hero element rules. Such rules are predefined strategies or guidelines that consider visual saliency and/or contextual importance to identify hero elements. For example, these rules might include the following: elements that overlap with high-saliency regions in the saliency mask are considered more visually important. Or certain types of elements (like headlines, key images, or buttons) may be given priority based on their role in the design. Or elements that are larger or centrally positioned might be prioritized as potential hero elements. Using the combined information from the saliency mask and the hero element rules applied to the scene graph, various embodiments then identify or detect hero elements. These are the elements deemed important for the design's visual and communicative impact.

With respect to clustering to identify hero elements, some embodiments group elements that are physically close to each other (e.g., via Euclidian distance) into clusters (e.g., via agglomerative clustering). This ensures that elements located near one another are treated as related, preserving the design's spatial organization. Additionally or alternatively, some embodiments group elements together that share similar visual characteristics, such as color, size, or shape, are grouped together. This helps create a cohesive visual experience by treating similar elements consistently. Additionally or alternatively, some embodiments group elements together that overlap with or are near regions of high saliency in the saliency map. This step focuses on grouping elements that are visually important, based on the saliency analysis. Once the elements are grouped into clusters, hero element rules are applied to determine which clusters (or elements within clusters) contain hero elements. For example, a cluster that includes a large, centrally positioned headline text and a key image in a region of high saliency might be identified as containing hero elements because these components are visually and contextually significant.

Some embodiments additionally or alternatively determine one or more animation rules based on saliency data and/or hero element detection. For example, a saliency map might show high saliency for the headline text and product image, moderate saliency for the call-to-action button, and low saliency for the decorative snowflakes. Based on the saliency data and/or elements being detected as hero elements, various embodiments use heuristic animation rules to decide how to animate each element. For example, a rule may be to “apply dynamic animations to high-saliency elements to immediately capture viewer attention.” Since the headline text and product image have high saliency, the rule dictates using dynamic animations for these elements. For example, some embodiments apply a “zoom-in” animation for the headline text and “a slide-in” from the left for the product image. Both animations would have a short duration (e.g., 1 second) with an “ease-out” easing function to create a quick, attention-grabbing effect. Animation is the process of creating the illusion of motion and change by displaying a series of still images or frames in succession. In the context of digital design, animation involves applying movement, transitions, or effects to visual elements (such as text, images, or shapes) to make them appear dynamic or interactive. For example, an image of a ball that appears to bounce up and down when a sequence of frames showing the ball at different positions is played quickly in succession is an animation. An animation sequence is a specific series of frames or steps that define the movement or change of visual elements over time within an animation. It details the order in which animations occur, including the timing, duration, and transitions of each element's movement or effect. An animation sequence can involve multiple elements and effects working together to create a coordinated animation. For example, in a presentation slide, an animation sequence might include first fading in the headline text, then sliding in an image from the left, and finally animating a bullet list to appear one item at a time.

Aspects of the present disclosure employ various technical solutions that have technical effects. For example, one technical solution is generating an animation output or sequence by generating a mask (e.g., a saliency mask) and/or detecting one or more hero elements to determine which elements are most visually and contextually important. Such functionality is indicative of automatic animation. This reduces the need for manual adjustments, the drilling described above, and minimizes user interaction with complex interfaces. Various embodiments intelligently decide on the animation parameters for each element based on pre-established animation rules and visual saliency, significantly reducing the time and effort required to set up animations.

Some embodiments eliminate the need for extensive animation expertise by automatically applying animation parameters or rules that consider visual element importance. This approach ensures that animations are both effective and visually coherent without requiring the user to understand or manually apply complex animation principles. The system effectively handles the intricacies of animation, such as setting keyframes and applying easing functions, making the animation process accessible to users without specialized knowledge.

Various embodiments further streamline the animation process by automating the selection and animation of elements based on their saliency and/or relevance. Instead of manually animating each element, the various embodiments automatically detect which elements need animation (hero elements) and applies predefined animation rules to these elements. This significantly reduces the time and effort needed to create animations, allowing users to achieve professional results quickly and with less manual intervention on user interfaces.

Various embodiments reduce I/O operations by automating the animation process, which minimizes the need for repetitive manual adjustments and frequent updates to the project data. By applying animations automatically based on generating a mask (e.g., a saliency mask), detecting hero elements, and/or animation rules, the system reduces the number of times data needs to be read from or written to storage. This decreases the overall I/O load on the system, reducing wear and tear on storage components and improving performance. Additionally or alternatively, various embodiments reduce memory usage by automating the animation process, reducing the need to keep large amounts of data in memory for manual editing and adjustments. By determining animations based on animation rules, detecting hero elements, and/or generating a mask (e.g., a saliency mask), the system can efficiently manage memory by loading only the necessary elements and properties for each animation pass. Additionally, because the process is less dependent on storing extensive undo/redo histories of manual actions, it can further reduce memory consumption.

### Example System

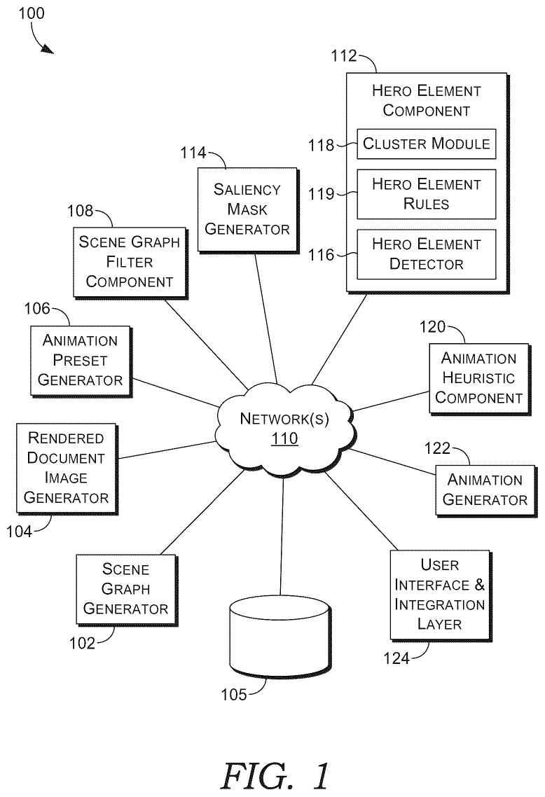

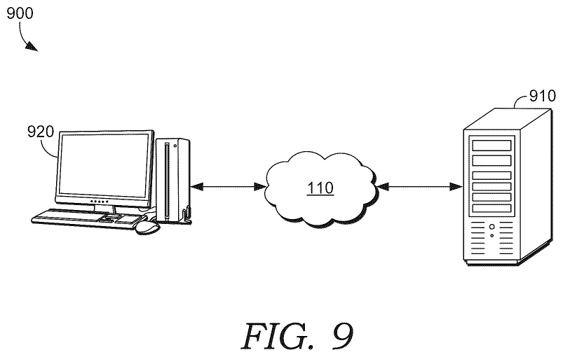

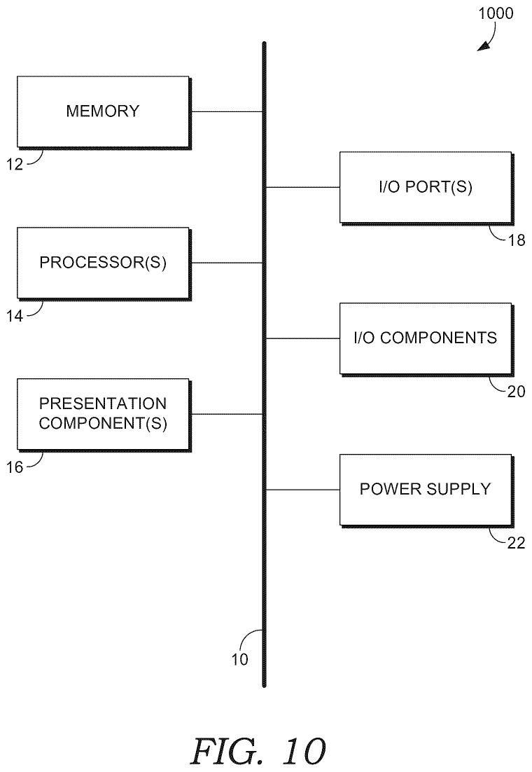

Referring now to FIG. 1, a block diagram is provided showing aspects of an example computing system architecture suitable for implementing some embodiments of the disclosure and designated generally as the system 100, according to some embodiments. The system 100 represents only one example of a suitable computing system architecture. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. For example, some or each of the components of the system may be located within a single computing device (e.g., the computing device 1000 of FIG. 10). Alternatively, some or each of the components may be distributed among various computing devices, such as in a distributed cloud computing environment. In some embodiments, the system 100 and each of the components are located within the server and/or user device of FIG. 9, as described in more detail herein.

The system 100 includes network(s) 110, which is described in connection to FIG. 9, and which communicatively couples components of system 100, including a scene graph generator 102, a rendered document image generator 104, an animation preset generator 106, a scene graph filter component 108, a saliency model 114, a hero element component 112, an animation heuristic component 120, an animation generator 122, a user interface and integration layer 124, and storage 105. The components of the system 100 may be embodied as a set of compiled computer instructions or functions, program modules, computer software services, logic gates, hardware accelerators, or an arrangement of processes carried out on one or more computer systems. The system 100 generally operates to generate an animation output or sequence from a single image or document.

The scene graph generator 102 is generally responsible for generating a data structure that represents one or more elements in a design document, such as a scene graph representing a hierarchical representation of all the elements in a design document, including their properties and relationships. For example, fa webpage design, the scene graph generator organizes elements like text, images, and buttons into a structured format that shows how each element is positioned and related to others.

In some embodiments, the scene graph generator 102 generates a scene graph by parsing the design document to identify all the individual elements and their properties. This involves reading the file format and extracting information about each element, including its type (e.g., text, image, and shape), position, size, color, layer order, and/or any other attributes. The scene graph generator 102 analyzes the spatial and logical relationships between elements to determine their hierarchy. Elements are organized into a parent-child relationship based on their grouping and nesting within the design document. For example, a text box and an image grouped together might form a parent node with the text box and image as child nodes. For each element identified, the scene graph generator 102 creates a node in the scene graph. Each node represents an individual element or a group of elements and contains data about its properties and its relationship to other nodes. This data includes transformation information (e.g., translation, rotation, scaling) and other attributes like opacity and blending modes. Nodes are connected to form a tree-like structure where each parent node represents a group of elements, and child nodes represent the elements within that group. This hierarchical structure mirrors the organization of elements in the design document. For example, if a button consists of text and a shape, the button would be a parent node, and the text and shape would be its children. The scene graph generator 102 then calculates the transformations (like position, rotation, and scale) for each node based on its parent node. This means that any transformation applied to a parent node is also applied to its child nodes, allowing for efficient manipulation of grouped elements. For example, moving a group node that contains multiple elements will move all child elements accordingly. After constructing the hierarchical structure, the scene graph generator 102 optimizes the scene graph for efficient processing. This might involve removing redundant nodes, merging similar nodes, or optimizing transformations. The final scene graph is then stored in memory (e.g., to storage 105), ready to be used for rendering, animation, or further processing.

The rendered document image generator 104 is generally responsible for producing a flat, visual representation of the entire design document by rendering all the elements from the scene graph into a single image. For example, it generates a visual preview of a flyer by combining all text, images, and graphics into one image, showing exactly how the flyer will look when viewed. In an illustrative example, the rendered document image generator 104 traverses the scene graph from the root node, rendering each element in the order determined by their hierarchy and layering, applying any transformations, such as scaling, rotation, and translation, as well as visual properties like color, opacity, and effects. As each element is rendered, it is composited onto a canvas, respecting the depth order and blending modes, to produce a single, flat image that visually represents the entire design document exactly as intended, showing all elements combined in their final layout. Additionally or alternatively, in some embodiments the rendered document image generator 1004 generates any suitable image, such as a digital image (e.g., a photograph) containing pixel data or raster graphics data.

The animation preset generator 106 is generally responsible for defining the initial animation presets, such as types, timing, and effects, to be applied to elements in the design document. An “animation preset” refers to a predefined set of parameters, characteristics, configurations that can be applied to animate elements. For example, an animation present can include sets default animation effects like “fade-in” for text and “slide-in” for images with a duration of 2 seconds for a marketing banner. Animation presets are generated automatically by the system (as built-in options) and/or users (for custom needs). For instance, Users can create their own animation presets by setting up a specific combination of animation parameters (like keyframes, timing, motion paths, easing curves, etc.) and then saving these configurations for reuse. This process allows users to develop personalized animations tailored to their specific project requirements or creative style.

The scene graph filter component 108 is generally responsible for selecting and/or discarding elements from the scene graph based on predefined criteria to focus on those most relevant for animation. For example, in some embodiments, the scene graph filter component 108 filters out/discards background elements for animation and selects key text and images for animation in a promotional flyer. The scene graph filter component 108 is described in more detail below.

The saliency mask generator 114 is generally responsible for generating one or more masks that indicate areas of visual importance and/or areas most likely to attract human attention. For example, in some embodiments, a saliency model generates the saliency mask. A saliency model is a computational model designed to predict which parts of an image are most likely to attract human attention. It generates a saliency mask by analyzing various visual features, such as color, contrast, intensity, and/or spatial frequency, to identify regions that stand out from their surroundings. These regions are assigned higher saliency values, creating a saliency map that highlights the most attention-grabbing areas in an image. The model can be based on traditional approaches using handcrafted features or on deep learning techniques that learn to predict saliency from large datasets of images and eye-tracking data.

While saliency models are specifically designed to predict visual saliency, other types of models, particularly those leveraging deep learning techniques, can also produce attention maps or masks that highlight important regions in an image. For example, such model may include Convolutional Neural Networks (CNN), transformer models, Object Detection and Segmentation models (e.g., YOLO and SSD), and Vision Transformers (ViTs). ViTs can generate attention maps. In ViTs, attention weights are computed for each token (image patch) based on its relationship with other tokens. These attention weights can be visualized as maps that indicate which parts of the image are being focused on, effectively serving as a form of saliency map.

The hero element component 112 detects and prioritizes key design elements (hero elements) for animation using the generated saliency map(s), the cluster module 118, and/or hero element rules 119. For example, the hero element component 112 uses the saliency model to highlight visually prominent areas in a poster and identifies the main headline and product image as hero elements to be emphasized.

The hero element component 112 includes a cluster module 118, hero element rules 119, and a hero element detector 116. The cluster model 118 is generally responsible for the cluster grouping design elements into clusters based on predefined criteria such as spatial proximity, visual similarity, and/or their association with regions of high visual saliency in saliency maps. It analyzes the scene graph to identify elements that are closely positioned, share similar visual characteristics (like color, size, or style), and/or or are located in high-saliency areas. By grouping these elements into clusters, the module allows the system to treat related elements as a single unit, facilitating coordinated animation and enhancing the visual coherence of the design. For example, in a webpage design, the cluster module might group a headline text, sub headline, and an image of a product into one cluster because they are positioned close to each other and are visually related, both in color and thematic content. Another cluster might include a set of social media icons positioned together in the footer. By clustering these elements, the system can apply animations that make the headline and product image appear simultaneously and in a synchronized manner, while the social media icons are animated more subtly, maintaining a cohesive and visually appealing layout.

The hero elements rules 119 are heuristic-based guidelines used to identify or detect hero elements that should be prioritized for animation based on their visual and/or contextual importance. These rules are determined by analyzing the saliency map generated from the rendered document image, which highlights visually prominent areas, and/or by evaluating properties within the scene graph, such as the element's type, size, position, and relevance to the design's message. The hero element detector 116 uses these rules to decide which elements are most critical for conveying the design's main message and should therefore receive the most attention in the animation process. For example, in a marketing flyer, hero element rules might prioritize a large, bold headline text and a central product image that appear in high-saliency regions of the flyer. The rule could state that elements with the highest visual saliency and those that occupy central positions in the design should be identified as hero elements. Consequently, the system would select the headline and product image as hero elements and apply prominent animations, like zoom-in or slide-in effects, to draw viewer attention effectively to these key components.

The hero element detector 116 is generally responsible for detecting hero elements by analyzing the clusters generated by the cluster module 118 and applying the hero element rules 119. It evaluates each cluster to determine whether it contains elements that meet the criteria set by the hero element rules 119, such as high visual saliency, central positioning, or significant size. By examining both the visual prominence of elements within each cluster and their contextual importance as defined by the hero element rules 119, the hero element detector 116 selects specific elements or entire clusters as hero elements, prioritizing them for animation to enhance the overall impact of the design.

The animation heuristic component 120 generates and/or applies predefined animation rules to determine how hero elements and other components should be animated (e.g., based on their saliency and importance). These rules take into account factors such as the visual importance of elements (as determined by the hero element detector 116), their spatial relationships, and/or the overall design context to decide on the type of animation, timing, duration, and/or style that will be most effective. The component dynamically adjusts these animation parameters based on the content and layout of the design, ensuring that each animation enhances visual focus and contributes to a cohesive and engaging presentation. For example, the animation heuristic component 120 uses rules to animate a hero element, like a central product image, with a “zoom-in” effect to attract attention, while subtler animations are applied to secondary elements.

The animation generator 122 produces the final animated output by applying the animation presets and/or animation rules (e.g., to the selected elements in the scene graph). For instance, the animation generator 122 processes parameters or presets—such as animation type, duration, start time, easing, and paths—by interpreting the hierarchical and relational data of the scene graph to animate elements according to the specified sequences and effects. In some embodiments, the generator 122 utilizes keyframing and interpolation techniques to create smooth transitions and movements, rendering each frame in succession to produce a final animated output that aligns with the design's visual and contextual goals, ensuring synchronization and visual coherence across all animated elements. Key framing involves setting specific “keyframes” at important points in an animation, where the properties of an element (such as position, rotation, scale, or opacity) are explicitly defined. The animation generator 122 then fills in the frames between these keyframes, creating the illusion of motion or change. Interpolation techniques (e.g., linear interpolation, Bezier interpolation) are algorithms used to calculate the intermediate frames between keyframes. In an illustrative example, the animation generator 122 combines animations such as “slide-in” for text and “fade-in” for images to create a cohesive animated advertisement.

The user interface and integration layer 124 provides the interface through which users interact with and integrates all components in the system 200 to create a seamless animation workflow. For example, the layer 124 allows users to preview the animated design, adjust parameters/presets, and finalize the animation through an intuitive interface in an animation software program.

Storage 105 generally stores information including data (e.g., design documents, scene graphs, images, etc.), generative text, computer instructions (for example, software program instructions, routines, or services), data structures, and/or models (e.g., saliency models) used in embodiments of the technologies described herein. Any one of these components can be accessed via any of the suitable components of the system 100. In some embodiments, storage 105 represents any suitable data repository or device, such as a database, a data warehouse, RAM, cache, disk, RAID, and/or a storage network (e.g., Storage Area Network (SAN)).

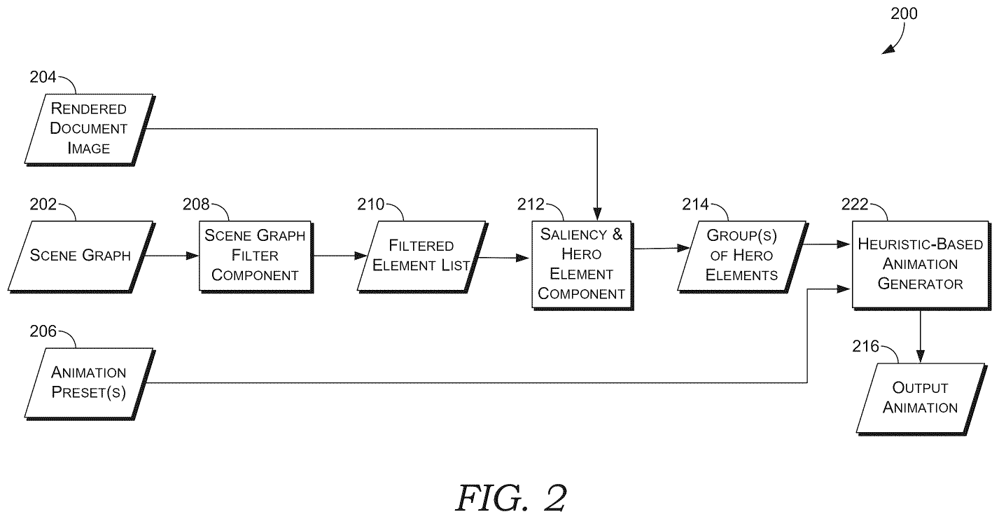

FIG. 2 illustrates an example pipeline 200 for generating an output animation, according to some embodiments. In some embodiments, the scene graph filter component 208 represents the scene graph filter component 108 of FIG. 1, the saliency and hero element component 212 represents the saliency mask generator 114 and the hero element component 112 of FIG. 1, the heuristic-based generator 222 represents the animation generator 122 of FIG. 1.

At a first time, the scene graph filter component 208 receives the scene graph 202, as input to generate filtered elements 210. In other words, the output of the scene graph filter component 208 is a filtered scene graph that includes only the design elements selected based on predefined criteria. This filtered scene graph contains elements that are deemed relevant or important for animation, discarding elements that are not significant for the animation process. In an example of an e-commerce webpage design, for instance, the scene graph filter component 208 outputs a filtered scene graph by selecting only the key elements for animation, such as the headline text “Flash Sale—50% Off!”, the product image of shoes, and the “Buy Now” call-to-action button, based on criteria like visual prominence and importance. Decorative background shapes and footer text are discarded, as they are deemed less relevant for animation, allowing the system to focus on animating the most impactful elements effectively.

The saliency and hero element component 212 takes the filtered elements 210 and/or the rendered document image 204 as input to generate groups (e.g., clusters) of hero elements. For instance, in the example of an e-commerce webpage design, the scene graph filter component 208 outputs a filtered scene graph by selecting only the key elements for animation, such as the headline text “Flash Sale—50% Off!”, the product image of shoes, and the “Buy Now” call-to-action button, based on criteria like visual prominence and importance. Decorative background shapes and footer text are discarded, as they are deemed less relevant for animation, allowing the system to focus on animating the most impactful elements effectively. Responsively, the hero element component 112 detects hero elements. For example, in the e-commerce webpage design example, after the saliency model generates a saliency mask that highlights visually prominent areas like the headline text and product image, the hero element component 112 detects hero elements by analyzing this saliency data alongside the filtered scene graph in 210. The component applies heuristic rules to determine which elements within the high-saliency regions are most critical for conveying the design's message. For instance, it might identify the headline text “Flash Sale—50% Off!” and the product image of the shoes as hero elements because they are both visually prominent and central to the design's objective of promoting a sale, ensuring these elements are prioritized for animation.

The heuristic-based generator 222 then takes, as input, the animation presets 206 and/or the group(s) of hero element 214 to generate an output animation 214. In the e-commerce webpage design example, after the hero element component 112 detects hero elements such as the headline text “Flash Sale—50% Off!” and the product image of the shoes, the animation generator 222 creates the output animation by applying one or more (e.g., a subset) of the appropriate animation presets 206 and/or animation rules to these elements. For example, the animation generator 222 takes the predefined animation presets and adjusts them based on the detected hero elements'importance and visual prominence, ensuring that these key elements are highlighted effectively. For instance, it might apply a dynamic “zoom-in” effect to the headline text and a “fade-in” effect to the product image, creating an engaging animation sequence that draws viewer attention to the most critical elements of the design.

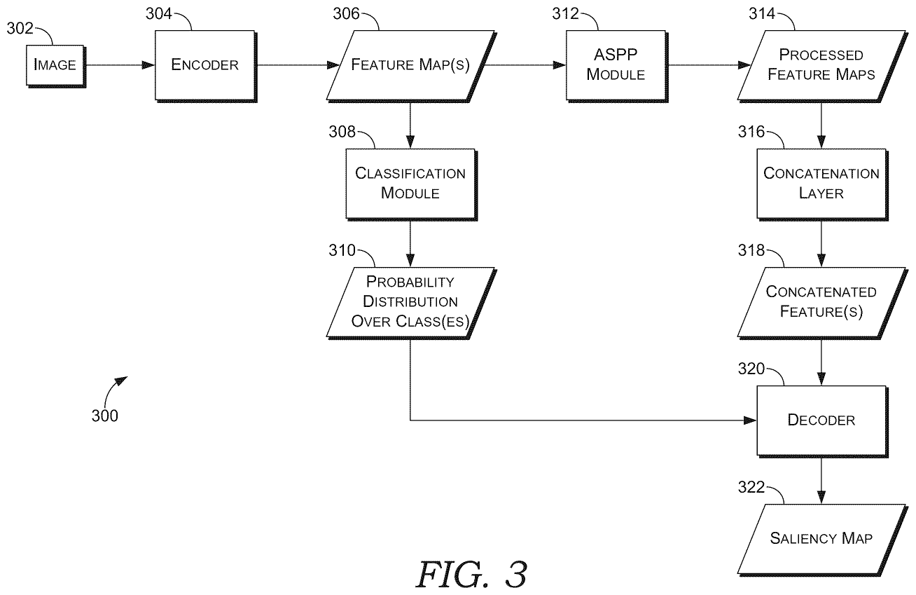

FIG. 3 is an example pipeline 300 of a saliency model, according to some embodiments. In some embodiments, the pipeline 300 represents the functionality performed by the saliency mask generator 114 of FIG. 1. In some embodiments, the pipeline 300 represents the architecture of a Unified Model of Saliency and Importance (UMSI). This model is designed to analyze visual content to predict both saliency (e.g., where people are likely to look) and/or importance (which parts of the content are most meaningful or significant).

At a first time, the encoder 304 takes the image 392 (e.g., a rendered document image) as input to produce one or more feature maps 306. The encoder 304 thus processes the input image (an image of a poster) to extract feature maps. These feature maps 306 capture essential details about the visual content, such as edges, textures, colors, and shapes. In some embodiments, the encoder includes multiple layers that represent different stages of feature extraction, such through convolutional neural networks (CNNs). Each successive layer captures more complex features. For example, the encoder 304 generate feature maps that highlight the edges of the headline text “Flash Sale—50% Off!” and the outline of the product image, providing detailed visual data that helps the model understand which areas of the design are most visually significant and should be considered for saliency and importance.

The Atrous Spatial Pyramid Pooling (ASPP) Module 312 takes the feature maps 306 generated by the encoder 304 and applies several atrous (dilated) convolutions with different rates. This technique allows the saliency model to capture information at multiple scales, effectively understanding both fine details and more extensive contextual information in the image. The ASPP module 312 outputs a set of feature maps 314 that have been processed to consider various spatial scales. By using atrous convolutions, the ASPP module 312 effectively increases the receptive field without reducing the resolution, allowing it to extract features at various scales. This enables the module 312 to recognize both fine details and broader patterns within an image, which is useful for accurately identifying elements of varying sizes and importance in tasks like semantic segmentation or, in the context of the e-commerce example, determining the visual saliency of different design components such as text and images.

The concatenation Layer 316 is responsible for generating concatenated features 318. After the ASPP module 312, the feature maps 314 are concatenated (combined) along the depth dimension. This step aggregates the multi-scale features into a single, unified representation that includes information from all processed scales. For example, suppose the ASP module 312 generates several sets of feature maps 314 with different levels of detail using various dilation rates. One set of feature maps 314 might capture fine details such as the sharp edges of the text “Flash Sale—50% Off!”, while another set captures broader patterns like the overall shape and color of the product image. The concatenation layer 316 takes these multiple sets of feature maps and combines them into a single output tensor 318 by stacking them along the channel dimension. This unified output now contains comprehensive information from all feature maps, enabling the model to analyze the image with both fine and broad contextual understanding.

The decoder module 320 takes the concatenated features 318 and transforms them back into a spatial representation, ultimately outputting a saliency map 322. This saliency map visually highlights the areas of the input image that are most likely to attract human attention (e.g., indicated by bright areas in the output image). For example, in the e-commerce webpage design, the decoder 320 starts with the high-dimensional, multi-scale feature maps 314 generated by the encoder and ASPP module 312, which contain detailed information about the visual content, including the headline text and product image. The decoder 320 then applies transposed convolutions or upsampling operations to gradually increase the resolution of these feature maps 314, refining and reconstructing the details to produce a final output, such as a saliency map.

In parallel to the saliency pathway, the saliency model also includes a classification module 308. In some embodiments, the classification module 308 applies a series of fully connected layers or 1×1 convolutions to the feature maps 306 to generate a probability distribution over predefined classes, such as “important” or “not important.” This probability distribution provides a preliminary assessment of the importance of various regions in the image. The classification module 308 outputs a probability distribution that indicates how likely each region is to attract viewer attention. This distribution is then used by the decoder 320 to focus on areas with higher probabilities, guiding the refinement process to generate a precise saliency map 322 that highlights key elements like the headline text and product image, which are deemed most visually important. The output 310 of the classification module 308 is thus fed into the decoder 320, which uses this information to guide the upsampling and refinement processes, ultimately generating the detailed saliency map 322 that highlights the most visually important areas in the image, such as the headline text and product image in the e-commerce webpage design.

Although the saliency model described in FIG. 3 is illustrated as having a Convolutional Neural Network (CNN)-based architecture, it is understood that any suitable architecture may be used to generate a saliency mask. For example, Vision Transformers (ViTs), Graph Neural Networks (GNNs), or Recurrent Neural Networks (RNNs) with attention mechanisms are architectures than can alternatively or additionally be used to generate a saliency mask.

ViTs are transformer-based models that use self-attention mechanisms to process image data. They split an image into patches, encode these patches, and learn the relationships between them to understand visual importance. ViTs can generate saliency masks by using the attention maps produced during the classification or prediction process. The self-attention weights highlight which parts of the image contribute most to the model's decision. These weights can be aggregated to create saliency maps that show visually important regions. The output attention scores serve as an importance measure, which can be reshaped into a saliency mask that emphasizes areas of high visual focus.

GNNs operate on graph-structured data, making them suitable for modeling relationships between different components of an image, such as pixels, regions, or object parts. In the context of saliency, GNNs can be used to model spatial relationships between image regions by treating each pixel or patch as a node in a graph. The model can learn to propagate importance signals through the graph based on connectivity and feature similarity. By aggregating these signals, the GNN can highlight nodes (pixels) that are most relevant, forming a saliency mask that emphasizes key regions.

RNNs, typically used for sequence data, can be combined with attention mechanisms to focus on specific parts of an input sequence, which in the case of images, can be sequences of pixels or regions. When applied to images, RNNs with attention can sequentially process patches or pixel rows and use attention weights to determine which parts of the image are most significant at each step. The attention scores can then be compiled to generate a saliency mask, highlighting the most attended regions.

Reinforcement learning (RL) models can be trained to focus on regions of an image that are rewarded as important based on a predefined criterion, such as visual saliency. RL agents can learn policies that navigate through an image, assigning higher attention scores to areas that yield higher “rewards” based on their visual features. Over time, the agent learns to map the image into a saliency mask that highlights these key regions.

Attention-Augmented Convolutional Models are hybrid models that combine CNNs with attention mechanisms, enhancing the model's ability to focus on specific regions of an image by learning spatial attention maps. The attention modules learn to weigh different regions of the feature maps generated by the CNN layers, effectively creating a spatial focus that can be directly interpreted as a saliency mask. Other examples include transformer models, Object Detection and Segmentation models (e.g., YOLO and SSD), as described herein.

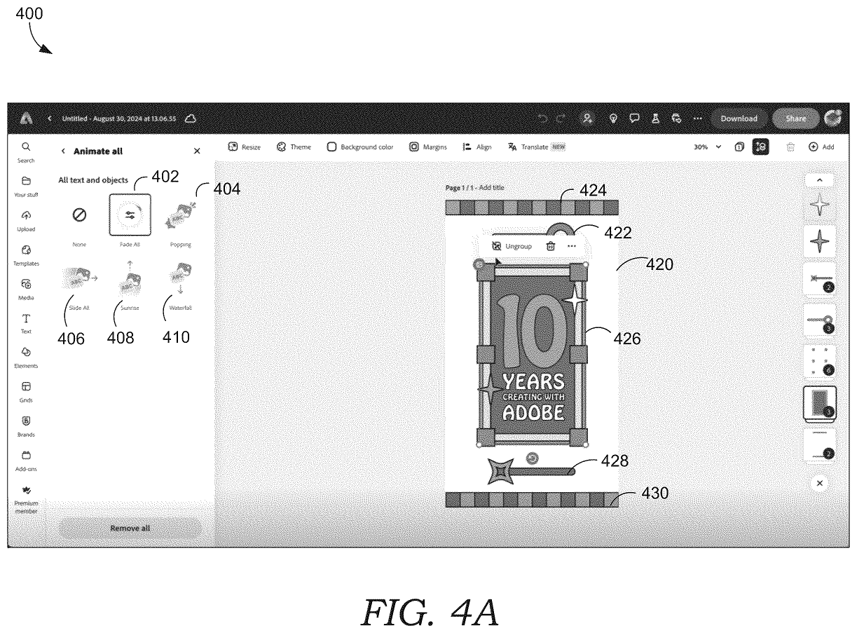

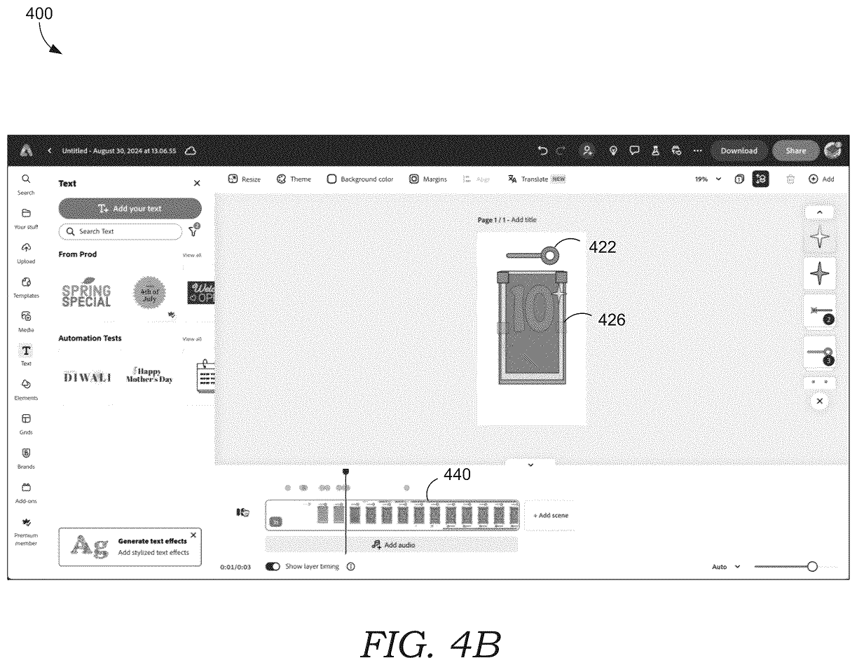

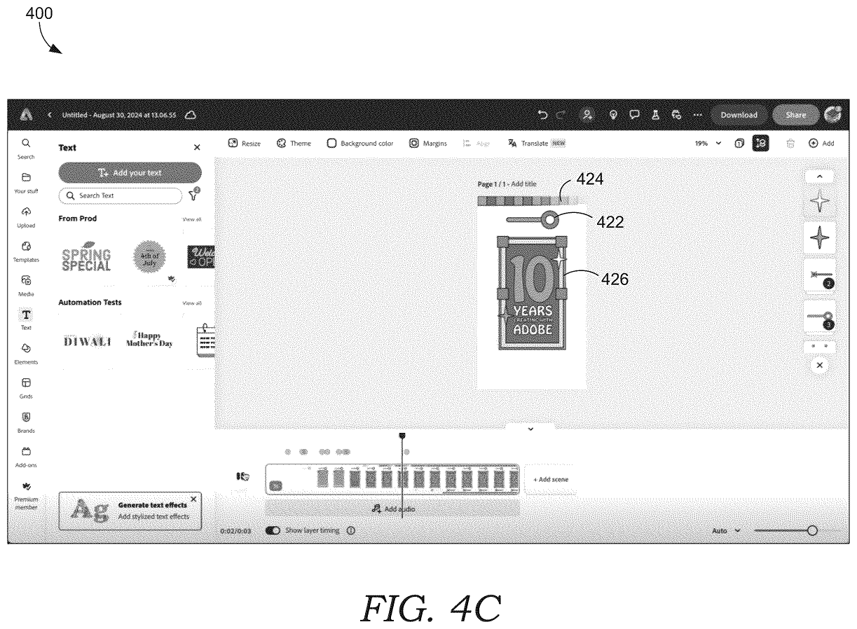

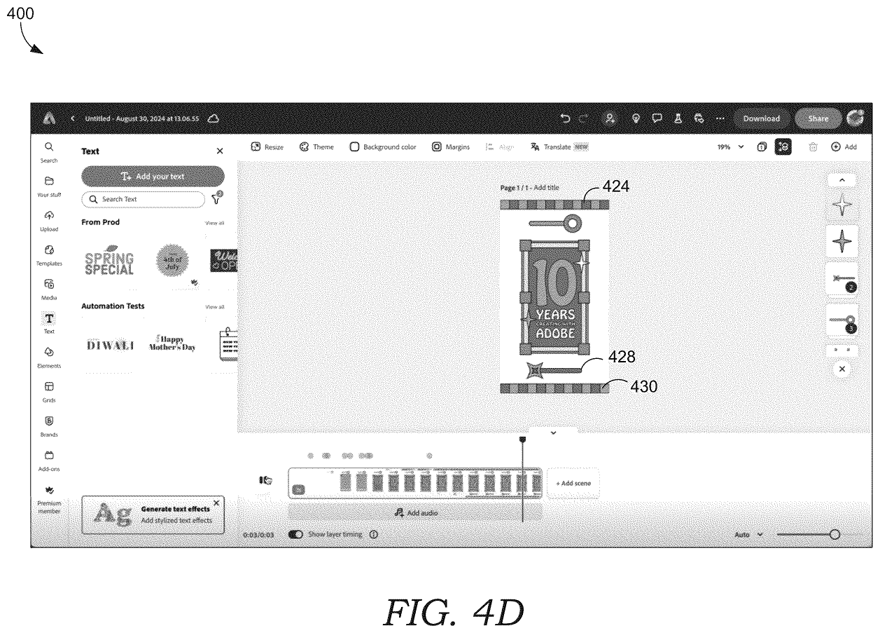

FIG. 4A is a screenshot of a user interface page 400 illustrating a static design document 420 before a request is made to generate an animation, according to some embodiments. The page 400 includes a left pane of user interface elements 402, 404, 406, 408, and 410, each of which correspond to animation presets (e.g., as generated by the animation preset generator 106) or different styles of animation sequences. The static design document 420 includes multiple elements 420, 422, 42, 426, 428, and 430, which make up the design document 420.

The “Fade All” animation style (corresponding to 402) involves smoothly transitioning all elements from complete transparency (invisible) to full opacity (fully visible) simultaneously. This effect creates a gentle, gradual reveal of all elements on the screen, which can add a subtle and elegant introduction to the design. This effect may be used in presentations or slideshows where a calm and cohesive appearance of elements is desired without drawing attention to individual components. The “Popping” animation style (corresponding to 404) makes elements appear as if they are popping onto the screen from a smaller size to their full size rapidly. This effect is characterized by a quick scaling-up motion that gives the impression of elements bursting or popping into view. This style is ideal for highlighting specific elements or creating a dynamic, energetic feel in a design, often used in advertisements or engaging slideshows to grab the viewer's attention quickly.

The “Slide All” animation style (corresponding to 406) moves all elements from off-screen positions into their final locations on the screen, usually from the left, right, top, or bottom. All elements slide in together, maintaining their relative positions as they animate into view. This effect may be used to introduce content in a structured manner, suitable for slides or interfaces where a clean, organized presentation is needed. The “Sunrise” animation style (corresponding to 408) gradually lifts elements from below the screen upwards, mimicking the natural motion of a sunrise. Elements start off-screen at the bottom and slowly rise to their designated positions, often accompanied by a fade-in effect. This style is used to create a serene, uplifting animation sequence, perfect for presentations or designs that aim to convey warmth, optimism, or a fresh beginning.

The “Waterfall” animation style (corresponding to 410) staggers the appearance of elements one after another, as if cascading down a waterfall. Each element appears or moves in sequence, creating a flowing, sequential animation that draws attention downwards or across the design. This effect may be used in infographics or tutorials, where presenting information in a step-by-step or hierarchical order enhances comprehension and engagement.

FIG. 4B is a screenshot of the user interface page 400 of FIG. 4A, illustrating a beginning step of a “Waterfall” animation style in response to a user request to generate a corresponding animation sequence, according to some embodiments. In some embodiments, in response to receiving an indication that the user has selected the user interface element 410 (corresponding to the “Waterfall” animation style), at a first time and as part of a first animation step in an animation sequence, the element 422 is presented, followed by a second step in the animation sequence to present element 426 in a “Waterfall” style.

More specifically, in some embodiments, in response to receiving the indication that the user has selected the user interface element 410, the rendered document image generator 104 converts the design document 400 into an image, the scene graph filter component 108 then filters the corresponding scene graph, the saliency mask generator 114 responsively generates a corresponding mask that indicates which of the elements in the rendered document image of the design document 400 are likely to attract human attention, the hero element component 112 detects hero element(s), the animation heuristic component 120 determines one or more animation rules, and the animation generator 122 begins the process of the waterfall animation sequence, as illustrated in FIG. 4B. As illustrated in FIG. 4B, a user interface element 440 is also presented, which illustrates the different layers (i.e., steps in the animation sequence) and timing. The start times determine the ordering and pacing of the animation effect. For example, important elements should show up first, and texts should show up in a left to right and top to bottom order.

FIG. 4C is a screenshot of the user interface page 400 of FIG. 4A, illustrating an intermediate step of the “Waterfall” animation style sequence initiated in FIG. 4B, according to some embodiments. As illustrated in FIG. 4C, after the first two steps of the Waterfall animation sequence where elements 422 and 426 are presented (and also illustrated in FIG. 4B), a third element 424 corresponding to a third step in the Waterfall animation sequence is presented.

FIG. 4D is a screenshot of the user interface page 400 of FIG. 4A, illustrating a last-in-time step of the “Waterfall” animation style sequence continued from FIG. 4C, according to some embodiments. As illustrated in FIG. 4D, after the third element 424 corresponding to the third step in the Waterfall animation sequence is presented (which is illustrated in FIG. 4C), a fourth element 428 corresponding to a fourth step in the Waterfall animation sequence is presented, followed by a fifth element 430 corresponding to a fifth step in the Waterfall animation sequence.

### Example Flow Diagrams

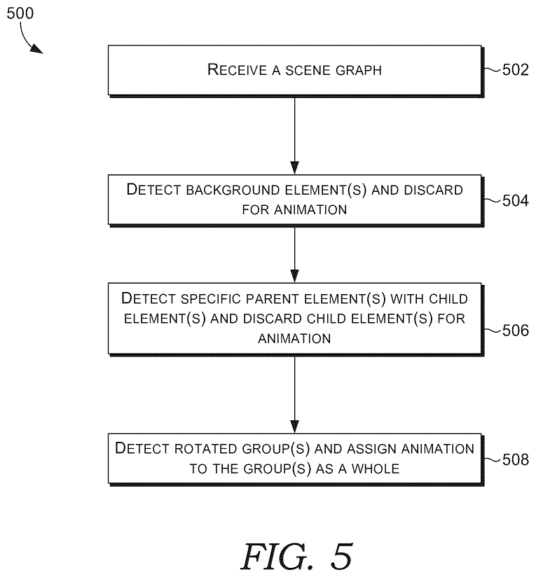

FIG. 5 is a flow diagram of an example process 500 for filtering a scene graph, according to some embodiments. In some embodiments, the process 500 represents the functionality that the scene graph filter component 108 performs. The process 500 (and/or any of the functionality described herein, such as process 600, 700, 800, and 900) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (e.g., as described with respect to FIG. 1 through FIG. 11). The computer-implemented method, the system (that includes at least one computing device having at least one processor and at least one computer readable storage medium), and/or the computer readable medium as described herein may perform or be caused to perform the process 500 or any other functionality described herein.

Per block 502, some embodiments first receive a scene graph. Per block 504, some embodiments detect one or more background elements in the scene graph and discard for animation. For example, when the scene graph filter component 108 analyzes the scene graph, it calculates the bounding box area for each element. If an element's bounding box occupies more than 80% (or other threshold-related value) of the canvas area, the scene graph filter component 108 classifies it as a background element. This is because such a large element is likely intended to serve as a background rather than a focal point. Identifying background elements is useful for ensuring that the main content (foreground elements) is appropriately highlighted or animated without being overshadowed by the background.

In an illustrative example of block 504, the scene graph filter component 108 determines the rectangular boundary that completely encloses the element within the design document (and/or scene graph). It identifies the element's position, width, and height on the canvas, typically by analyzing the element's coordinates in the scene graph or its placement within the design. The scene graph filter component 108 then calculates the area of the bounding box by multiplying its width and height. This calculation is performed for each element to determine its size relative to the total canvas area, which helps classify elements as either background or foreground based on predefined criteria, such as whether the bounding box area exceeds 80% of the canvas area. Some embodiments then discard the background area. To “discard” as described herein means masking (e.g., create a mask that hides the background), flagging (e.g., mark the background elements with a tag that instructs to ignore during animation), completely deleting from the graph/design document, and/or layer separation.

Per block 506, some embodiments then detect specific parent elements with child element and discard child elements for animation. In design documents, icons, for example, often include multiple smaller shapes grouped together to form a cohesive symbol or graphic. For example, an icon of a star might be made up of several smaller polygons or lines. Animating each of these small, individual child shapes can be computationally intensive and might result in animation artifacts—unintended visual glitches or irregularities in the animation. These artifacts can occur because animating many closely packed, detailed elements can cause overlapping, jittery movement, or unexpected interactions between shapes. To avoid these issues, the scene graph filter component 108 identifies the top-level group that represents the entire icon (or other specific parent) rather than its individual components. This top-level group is a single parent node that encompasses all the child shapes of the icon. By animating this group as a whole, rather than the individual shapes, the animation is smoother and more cohesive, reducing the risk of artifacts.

The scene graph filter component 108 begins by traversing the scene graph from its root. The scene graph contains nodes that represent all elements in the design, including their grouping and nesting. Each node corresponds to an element or group of elements and has information about its parent and child nodes. As it traverses, the scene graph filter component 108 identifies nodes that are marked as groups. A group node is one that contains child nodes representing multiple elements combined into a single unit. In vector graphics, for example, icons are often stored as group nodes that encapsulate all the individual shapes making up the icon.

The scene graph filter component 108 checks each group node to see if it contains child nodes that are shapes or smaller elements. If a group node has child nodes that represent the various parts of an icon (such as paths, lines, or polygons), it considers this group as a potential top-level group for the icon. The scene graph filter component 108 evaluates the characteristics of these group nodes, such as their size, position, and relationship to other elements in the design. If a group node encompasses multiple child shapes (or other threshold quantity) that form a coherent symbol and does not have a parent group, it is identified as the top-level group representing the icon. The graph filter component 108 then selects this group node as the top-level group for the icon. All animations will be applied to this node, and the child elements (individual shapes within the icon) will be discarded from the animation process to prevent unnecessary complexity and animation artifacts.

In an illustrative example, consider a design document containing an icon of a house, which is made up of several shapes: rectangle for the main body of the house, triangle for the roof, small rectangles for windows and doors. Particular embodiments traverse the scene graph and finds a group node labeled “House Icon.” It checks that this “House Icon” group node has child nodes representing the rectangle (body), triangle (roof), and small rectangles (windows and doors). Since all these child shapes are part of a coherent symbol (the house icon) and are grouped together under the “House Icon” node, particular embodiments identify this node as the top-level group for the house icon. Particular embodiments then select the “House Icon” group node for animation and discards the child nodes (individual shapes) from the animation process. By animating the “House Icon” group as a whole, the scene graph filter component 108 ensures a smooth animation of the entire icon, avoiding the complexity and potential artifacts that could arise from animating each shape independently.

Per block 508, particular embodiments detect rotated group(s) and assign animation to the group(s) as a whole. A “rotated group” refers to a set of elements that are grouped together and then rotated as a single unit. This group could be any collection of elements, such as multiple shapes or images that are transformed together. For example, a cropped image within a group that is rotated to fit a design layout is considered a rotated group. When a group is rotated, applying animations to the individual child elements (such as moving or fading each element separately) can cause issues. Specifically, it can lead to incorrect animation start times and directions because the transformations (like rotation) alter how each child element's animation should be interpreted. This can result in animations that do not align properly, appear at the wrong times, or move in unintended directions. To manage this, some embodiments keep track of top-level groups that have been rotated. A top-level group is the main node in the scene graph that encompasses all the child elements. By identifying these groups, the system ensures that animations are applied correctly to the entire group, rather than just the individual children.

Some embodiments assign an animation preset to the rotated top-level group as a whole, which controls how the group is animated. This might involve applying a specific type of animation (such as a fade-in or slide) to the entire group, maintaining the visual coherence of the group despite its rotation. Some embodiments additionally or alternatively assign animation start times to all the children within the group. This means that while the group is animated together based on its preset, each child element still has its own specific timing for when its animation starts, relative to the group's overall animation. This approach ensures that animations are synchronized and aligned properly, accounting for the group's rotation and maintaining visual consistency.

In an illustrative example of block 508, consider a design document for a digital presentation slide that includes a rotated group of elements representing a rotated photo collage. The group consists of the following elements: image 1: a cropped square image of a landscape, image 2: a circular cutout of a person, image 3: a hexagonal image of a building, and a background shape: a decorative triangle behind the images. All these elements are grouped together and rotated 45 degrees to create a dynamic, tilted collage effect on the slide. The designer groups these images and the background shape into a single top-level group called “Photo Collage.” The entire “Photo Collage” group is then rotated 45 degrees clockwise to create a visually interesting tilted effect. If embodiments were to animate each image and the background shape individually without considering the rotation, it could result in incorrect animation start times and directions. For example, if Image 1 (the landscape image) is animated to slide in from the left without accounting for the group's rotation, it might not follow the correct angled path and could appear out of sync with the rest of the group. Various embodiments identify “Photo Collage” as a rotated top-level group because it has been rotated 45 degrees. It notes that this group requires special handling to ensure that all animations are correctly synchronized and aligned. Some embodiments thus assign an animation preset to the entire “Photo Collage” group. For instance, it might apply a “fade-in” animation to the whole group, ensuring that the collage appears together as a unified, rotated element.

While the entire group is animated using the “fade-in” preset, each child element (Image 1, Image 2, Image 3, and the background shape) is assigned specific animation start times. For example, Image 1 might start fading in first, followed by Image 2 and Image 3, with slight delays between each. The background shape might appear last to complete the effect. By treating the “Photo Collage” as a rotated top-level group and applying a unified animation preset while managing start times for each child element, this ensures that the animations are visually coherent and synchronized. The group fades in together, and each image appears in sequence, maintaining the correct rotation and creating a cohesive, dynamic animation that enhances the overall presentation slide.

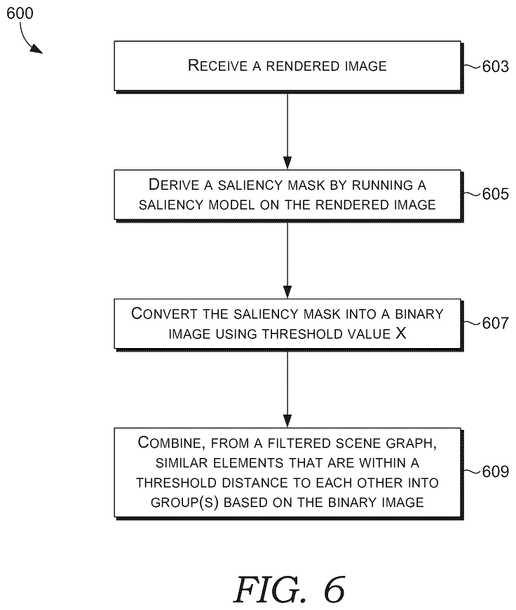

FIG. 6 is a flow diagram of an example process 600 for detecting one or more groups of hero elements, according to some embodiments. In some embodiments, the process 600 represents the functionality of the hero element component 112 of FIG. 1. Given the filtered elements from a scene graph, particular embodiments identify groups of hero elements. Detecting hero elements allows the writing of custom animation rules to improve the quality of the animation outputs. Per block 603, some embodiments first receive a rendered image (e.g., a rendered document image generated by the rendered document image generator 104 of FIG. 1). Per block 605, some embodiments derive a saliency mask by running a saliency model on the rendered image. For example, as illustrated in FIG. 3, a saliency model takes the image 302 to generate the final saliency map 322.

Per block 607, some embodiments then convert the saliency mask into a binary image using threshold value X (e.g., 0.5). For example, particular embodiments threshold the saliency mask by 0.5 and run connected components on the output to identify blobs of high saliency regions. In some embodiments, the saliency mask/map is a grayscale image where each pixel's intensity represents the saliency value, indicating how likely that pixel is to attract human attention based on visual features. Thresholding involves converting the grayscale saliency map into a binary image, where pixels are, for example, classified into two categories: high saliency and low saliency. A Threshold by 0.5 means that any pixel with a saliency value greater than 0.5 (on a scale from 0 to 1) is considered part of a high-saliency region and is set to 1 (white in the binary image), while pixels with a value of 0.5 or less are considered low saliency and are set to 0 (black in the binary image). Running connected components on the output is a process used to identify and label clusters of connected pixels in a binary image. In this context, it identifies set(s) or group(s) of white pixels (or other pixels that share a same value) that are connected to each other either horizontally, vertically, and/or diagonally. By running connected components analysis on the thresholded binary image, the various embodiments can identify distinct “blobs” or clusters of high-saliency pixels. Each blob represents a region of the image where pixels are closely packed together and are all above the saliency threshold, indicating a high-saliency area.

In an example illustration of block 607, the saliency map M is first analyzed to apply a threshold at 0.5, converting it to a binary image where high-saliency areas are highlighted. Then, particular embodiments perform connected components analysis on this binary image to group together all adjacent high-saliency pixels into blobs or regions. This process helps to identify and segment the image into regions that are visually prominent, which can then be further analyzed or used in subsequent steps of the animation process, such as determining which areas or elements should be emphasized or animated.

Per block 609, some embodiments combine, from a filtered scene graph, similar elements that are within a threshold distance to each other into group(s) (e.g., clusters) based on using the binary image. For example, some embodiments (e.g., the cluster module 118) run an agglomerative clustering algorithm on the filtered scene graph elements. Agglomerative clustering is a hierarchical clustering method that starts by treating each element as its own cluster and then progressively merges them based on their similarity until a desired number of clusters is reached. Some embodiments then set the max number of clusters requested to be the same number of saliency blobs extracted in block 607. Various embodiments then compute the pairwise distance matrix for the clustering using the scoring function below. The pairwise distance matrix measures the distances or dissimilarities between every pair of elements to be clustered. This matrix is based on the scoring function that quantifies how similar or different the elements are according to several criteria.

The scoring function is designed to group elements 1) close to 2) of the same type and 3) overlapping the same saliency regions together. In other words, the scoring function used in the clustering process is specifically designed to group elements that are spatially close to each other, of the same type (e.g., group elements of text or group elements of image), and that overlap the same saliency regions as identified in the saliency map. This helps ensure that elements that are visually and contextually related are clustered together. Below is a mathematical representation of the scoring function:

D[i,j]=iOU(i,j)+saliencyDiff(i,j)+distanceDiff(i,j)+typeDiff(i,j)

where D[i,j] is the distance between element i and element j, iOU is the intersection over union between the bounding boxes of elements i and j, respectively, “saliencyDiff” is the absolute difference between the mean saliency scores of elements i and j, respectively, “distanceDiff” is calculated by taking the exponential of the L2 distance between the center of the bounding boxes of elements i and j, respectively, and “typeDiff” is 0.5 if both elements are of text type, or alternatively is 0.0 otherwise (e.g., if both elements are of image type). Accordingly, the equation is a scoring function used to calculate the distance or dissimilarity between two elements, i and j, in the clustering process.

In some embodiments, while the binary image itself created in bock 607 is not directly used in the agglomerative clustering algorithm at step 609, the information from the saliency blobs extracted from this binary image is useful. The number of clusters in the agglomerative clustering algorithm is set to match the number of saliency blobs identified. Additionally, the saliency information influences the clustering process through the “saliencyDiff” component of the distance metric. The output of the 609 is group(s) of hero elements.

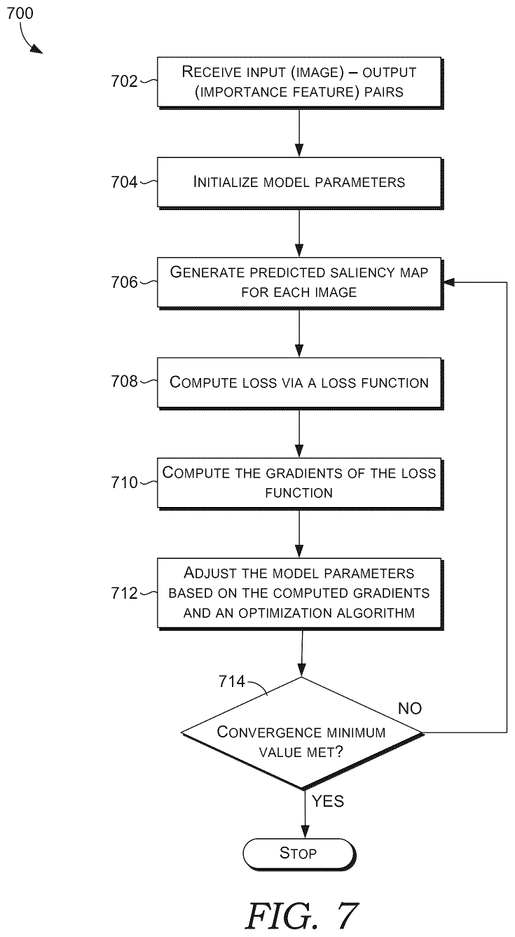

FIG. 7 is a flow diagram of an example process for training a machine learning model to generate a saliency mask, according to some embodiments. Per block 702, some embodiments receive input (image)—output (importance feature(s)) pairs. In other words, particular embodiments collect a set of images (e.g., rendered design document images) that will be used as the training dataset. Various embodiments obtain ground truth saliency maps for each image, which are, for example, created by human annotators or derived from eye-tracking data. These saliency maps serve as the target output for the model. Eye-tracking data refers to information collected from tracking and recording the movement and position of a person's eyes as they look at various stimuli, such as images, text, or user interfaces. This data typically includes details like the fixation points (where the gaze is focused), saccades (quick eye movements between fixations), gaze duration, and the sequence of visual exploration, which indicates areas that likely attract human attention.

Per block 704, some embodiments then initialize model parameters. For example, some embodiments initialize the weights and/or biases of the network. Weights can be initialized randomly or using a specific strategy like Xavier or He initialization. Per block 706, some embodiments then generate a predicted saliency map for each image in the dataset. Various embodiments thus feed the image into the model. The image goes through multiple layers of the network, such as convolutional layers, activation functions, pooling layers, and/or potentially fully connected layers, depending on the architecture. The model outputs a predicted saliency map that represents areas of the image where attention is likely to be focused. This is the raw output from the network's final layer, such as a sigmoid or softmax activation for probability maps.

Per block 708, some embodiments then compute loss via a loss function. In other words, some embodiments use a suitable loss function to compare the predicted saliency map with the ground truth saliency map to quantify the delta or how different the predicted saliency map is from the ground truth saliency map. For example, some embodiments compute a Binary Cross-Entropy Loss for pixel-wise classification problems or Mean Squared Error (MSE) for regression-type outputs. For example, some embodiments compute loss by computing:

Per block 710, some embodiments then compute the gradients of the loss function. For instance, some embodiments compute the gradients of the loss function with respect to each parameter in the model (weights and biases). In some embodiments, this is done using the chain rule to propagate the error backward through the network layers. Some embodiments also perform backpropagation, which adjusts the weights of the network in a way that minimizes the loss. The gradient of each weight is used to determine how much to change the weight to reduce the error.

Per block 712, some embodiments then adjust the model parameters based on the computed gradients and an optimization algorithm. For example, some embodiments use an optimization algorithm (such as Stochastic Gradient Descent (SGD), Adam, or RMSprop) to update the model parameters. The optimizer adjusts the weights using the gradients calculated during backpropagation. Some embodiments additionally adjust the learning rate during training to improve convergence, often reducing it over time as the model begins to converge.

Per block 714, some embodiments determine whether a convergence minimum value is met. Convergence is achieved when the model's parameters (such as weights and biases) are adjusted through backpropagation and gradient descent in such a way that the loss function consistently decreases and eventually stabilizes around the minimum value. At convergence, the model's prediction (e.g., block 706) are close to the ground truth saliency maps, indicating that the model has learned to accurately identify regions of an image that are visually important. When a model converges, it means that further training will no longer result in significant improvements in the model's ability to predict saliency maps. This indicates that the model has learned the optimal representations and patterns necessary to perform the task effectively. Achieving convergence is useful for ensuring that the model generalizes well to new, unseen images and consistently generates high-quality saliency maps.

If the convergence minimum value is not met, block 706 is repeated to introduce another epoch/forward pass and generate another saliency map (e.g., from a different input of the input-output pairs). Blocks 710, 712, and 714 are also repeated until the convergence minimum is met, at which point the process 700 stops. The above steps (from the generation of a saliency map (a forward pass) to optimization) are repeated for each batch of images in the dataset. Batches are processed one after another in each epoch. The entire training set is processed multiple times (epochs) to allow the model to learn and generalize. Each epoch consists of all training batches being fed through the network.

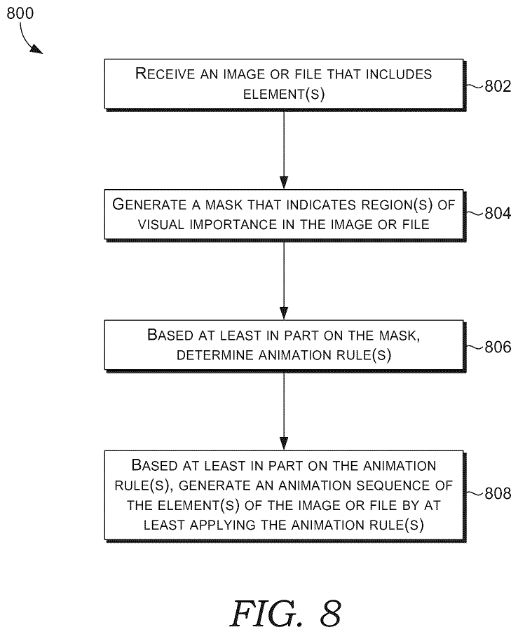

FIG. 8 is a flow diagram of an example process 800 for generating an animation sequence, according to some embodiments. Per block 802, some embodiments receive an image or file that includes one or more elements. In some embodiments, the image is representative of any suitable image, such as a digital photograph or a video frame. In some embodiments, the image is representative of a rendered document image (e.g., the rendered document image 204 of FIG. 2). The rendered document image is a visual representation of a design document (e.g., the design document 420 of FIG. 4A). In some embodiments, the design document represents the file at block 802, which is created in graphic design or layout software. For example, some embodiments first receive a design document and then generate a rendered image of the design document (e.g., as described with respect to the rendered document image generator 104 of FIG. 1). Some embodiments generate, from the design document, a scene graph that represents each element in the design document in a hierarchical structure where each node in the scene graph corresponds to an element or group of elements in the design document, as described, for example, with respect to the scene graph generator 102 of FIG. 1.

Per block 804, some embodiments generate a mask that indicates one or more regions of visual importance in the image or file (e.g., automatically at least partially responsive to the receiving of the image or file. For example, in some embodiments block 804 includes the functionality as described with respect to the saliency mask generator 114 of FIG. 1. A “mask” is any suitable data structure and/or technique used to control which parts of an image, file object, or surface are affected by certain operations or transformations. Masks may be used in graphics and image processing to selectively hide or reveal parts of an image, allowing for more precise and localized adjustments. In an illustrative example of block 804, some embodiments generate a saliency mask (e.g., the saliency map 322 of FIG. 3) by providing a representation (e.g., a preprocessed version, such as a matrix, vector, or greyscale version) of the rendered image as input to a saliency model. The saliency mask indicates one or more regions of visual importance within the rendered image. For example, in some embodiments the saliency mask is a greyscale image or a heat map that indicates which pixels of the one or more regions are likely to attract human attention. In some embodiments, the generating of the mask is based on training a machine learning model on a dataset of images with labeled regions of visual importance as described, for example, with respect to the training process 700 of FIG. 7.

Saliency refers to how likely a particular region of the image or file is to stand out and attract human attention. Salient regions are typically those that have distinct colors, textures, edges, or contrasts compared to the surrounding areas. With respect to a greyscale image, the saliency mask is an image where the intensity of each pixel (ranging from black to white) indicates the level of saliency. Higher intensity (closer to white or white value threshold) means that the region is more likely to attract attention, while lower intensity (closer to black or black value threshold) indicates less saliency. With respect to a heat map, this is a more colorful representation where colors (like red, yellow, blue, etc.) are used to indicate the level of saliency. Typically, warmer colors (like red and yellow) represent areas of higher saliency, while cooler colors (like blue) represent areas of lower saliency. The purpose of a saliency mask is to predict or identify which parts of an image or file are most likely to draw the viewer's eye. This is based on various visual features such as contrast, color, edges, and/or texture. The regions highlighted by the saliency mask are those that stand out and are thus more likely to be noticed first by a human observer.

Per block 806, based at least in part on the mask, some embodiments determine one or more animation rules. In some embodiments, block 806 includes the functionality described with respect to the animation heuristic component 120 of FIG. 1. In an illustrative example of block 806, if a saliency mask indicates that a particular character's face is likely to draw viewer attention, the animation rules could ensure that the character's facial expressions are more pronounced and dynamic. Additionally, various embodiments may use smoother or more exaggerated movements for this character to maintain engagement, directing the viewer's focus according to the saliency data. This approach allows the animation to adapt dynamically, emphasizing the most attention-grabbing elements in the scene.

In some embodiments, block 806 additionally or alternatively includes determining one or more animation parameters. An “animation parameter” refers to one or more characteristics (e.g., animation presets) associated with the animated output and/or the one or more animation rules indicated in block 806 that dictate how the animation output should be applied to different elements within the file or image. For example, in the context of an animation preset, an animation parameter could include attributes like the duration of the animation, the delay before the animation starts, the type of movement/animation output (such as fade, slide, or zoom), and the easing function (how the speed of the animation changes over time, like ease-in or ease-out). If an animation preset is set to “fade-in,” the animation parameters might specify that the fade lasts 2 seconds, starts 0.5 seconds after the element appears on the screen, and uses an ease-out easing function to create a smooth, gradual appearance. These parameters ensure the animation behaves consistently across different elements when the preset is applied. In some embodiments, each animation parameter includes an animation preset name (e.g., “spin”, “tumble”, “fade”) and/or a set of parameters like duration, personality, or direction.

In some embodiments, block 806 additionally or alternatively includes determining animation presets that include a set of predefined animation styles that are selectable by a user such that the determining of the one or more animation rules include determining how the animation presets are applied or changed, and wherein the generating of the animation sequence is based on the determining how the animation presets are applied or changed. Various embodiments thus animation presets, which are predefined sets of animation styles and effects that users can choose from. Examples of this are described with respect to UI elements 402, 404, 406, 408, and 410 of FIG. 4A. These presets simplify the animation process by providing a variety of ready-made animation options, such as “fade-in” or “slide-left,” that users can easily apply to different elements within a design. Various embodiments then determine how these selected animation presets will be implemented or modified based on specific criteria or user inputs. This includes adjusting the parameters of the presets, such as timing, duration, or sequence, to fit the particular needs or context of the design, ensuring the animation aligns with the desired visual outcome.

Per block 808, based at least in part on the animation rule(s), some embodiments generate an animation sequence of the element(s) of the image or file by at least applying the animation rule(s). Alternatively or additionally, block 808 represents generating an animated output associated with the image or file based at least in part detecting of the one or more hero elements. Alternatively or additionally, block 808 represents generating an animated output by at least applying the one or more animation parameters to the design document based at least in part on the saliency mask.

The generating of the animated output transforms the design document into an animated design document. An “animation sequence” is a series of steps that define how animations unfold over time, outlining the specific order and timing in which different elements are animated. Each step in the sequence may involve applying different animation effects (such as fade, slide, or zoom) to one or more elements, often with specific parameters like duration and delay to control the flow of the animation. For example, in a presentation slide, an animation sequence might begin with a step that fades in the title text, followed by a second step that slides in an image from the left, and then a final step that animates bullet points one by one with a pop effect.

In some embodiments, an “animation output” includes an animation sequence. In some embodiments, the “animation output” additionally or alternatively only represents a single step or effect (e.g., in a sequence of steps/effects). In some embodiments, an “animation output” additionally or alternatively is the final, rendered result of the animation process, which includes all the applied animation effects, transitions, and sequences. It represents the complete visual presentation after the animation steps have been executed, which may be in the form of a video file, an interactive web animation, or a series of animated frames. For example, after creating and applying an animation sequence to elements in a design document (e.g., text fading in and images sliding in), the animation output is the final video or interactive content that the viewer sees, showcasing the smooth transitions and animations as intended.

In some embodiments, the generation of the animation sequence at block 808 is based on a single user input representative of a request to convert the image or file into the animation sequence. Such “single user input” represents a “one-click” solution such that no other user input selections are needed to animate a document except the single user input, unlike existing technologies. For example, referring back to FIG. 4A through FIG. 4D, in response to receiving an indication that the user has selected the “waterfall” UI element 410, particular embodiments automatically perform all of the steps of the waterfall animation corresponding to FIGS. 4B, 4C, and 4D without the user having to manually perform or otherwise engage in user input to complete the waterfall animation sequence.

In some embodiments, the generation of the animation sequence of the one or more elements is further based on filtering the scene graph by selecting or discarding specific elements from the scene graph based on predefined criteria. For instance, some embodiments filter a representation (e.g., a scene graph that indicates) of the one or more design elements of the image based on predetermined criteria. Examples of such filtering is described with respect to the process 500 of FIG. 5 and the scene graph filter component 108 of FIG. 1.

Some embodiments convert a mask into a binary image using a threshold value (e.g., as described with respect to block 607 of FIG. 6) and combine elements of a scene graph that are within a threshold distance to each other into one or more clusters based on using the binary image (e.g., as described with respect to block 609 of FIG. 6). In this way, the generating of the animation sequence is further based on the converting and the combining.

Some embodiments detect one or more hero elements in a scene graph based analyzing overlap between one or more design elements in the scene graph and one or more regions of high saliency in the mask, and wherein the generation of the animation sequence is further based on the detecting of the one or more hero elements. In some embodiments, this process involves thresholding the saliency map to highlight the most visually important areas, identifying connected regions (blobs) of high saliency (e.g., as described in blocks 605 and/or 607 of FIG. 6), and clustering the design elements based on their spatial and visual relationships to these regions (e.g., as described with respect to block 609 of FIG. 6). The generation of the animation sequence is then further tailored based on these detected hero elements, ensuring that they are prominently featured in the final animation.

### Exemplary Operating Environments

Turning now to FIG. 9, a schematic depiction is provided illustrating an example computing environment 900 for recommending one or more color values for applying to an input image, in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. For example, there may be multiple servers 910 that represent nodes in a cloud computing network. Various functions described herein as being performed by one or more entities may be carried out by hardware, firmware, and/or software. For instance, various functions may be carried out by a processor executing instructions stored in memory.

The environment 900 depicted in FIG. 9 includes a prediction server (“server”) 910 that is in communication with the network 110. The environment 900 further includes a client device (“client”) 920 that is also in communication with the network 110. Among other things, the client 920 can communicate with the server 910 via the network 110, and generate for communication, to the server 910, a request to animate an image and/or a design document. In various embodiments, the client 920 is embodied in a computing device, which may be referred to herein as a client device or user device, such as described with respect to the computing device 1000 of FIG. 10.

In some embodiments, each component FIG. 1 is included in the server 910 or the client device 920. Alternatively, in some embodiments, the components in FIG. 1 are distributed between the server 910 and client device 920.

The server 910 can receive the request communicated from the client 920, and can search for relevant data via any number of data repositories to which the server 910 can access, whether remotely or locally. A data repository can include one or more local computing devices or remote computing devices, each accessible to the server 910 directly or indirectly via network 110. In accordance with some embodiments described herein, a data repository can include any of one or more remote servers, any node (e.g., a computing device) in a distributed plurality of nodes, such as those typically maintaining a distributed ledger (e.g., block chain) network, or any remote server that is coupled to or in communication with any node in a distributed plurality of nodes. Any of the aforementioned data repositories can be associated with one of a plurality of data storage entities, which may or may not be associated with one another. As described herein, a data storage entity can include any entity (e.g., retailer, manufacturer, e-commerce platform, social media platform, web host) that stores data (e.g., names, demographic data, purchases, browsing history, location, addresses) associated with its customers, clients, sales, relationships, website visitors, or any other subject to which the entity is interested. It is contemplated that each data repository is generally associated with a different data storage entity, though some data storage entities may be associated with multiple data repositories and some data repositories may be associated with multiple data storage entities. In various embodiments, the server 910 is embodied in a computing device, such as described with respect to the computing device 1000 of FIG. 10.

Having described embodiments of the present invention, an exemplary operating environment in which embodiments of the present invention may be implemented is described below in order to provide a general context for various aspects of the present invention. Referring initially to FIG. 10 in particular, an exemplary operating environment for implementing embodiments of the present invention is shown and designated generally as computing device 1000. Computing device 1000 is but one example of a suitable computing environment and is not intended to suggest any limitation as to the scope of use or functionality of the invention. Neither should the computing device 1000 be interpreted as having any dependency or requirement relating to any one or combination of components illustrated.

Looking now to FIG. 10, computing device 1000 includes a bus 10 that directly or indirectly couples the following devices: memory 12, one or more processors 14, one or more presentation components 16, input/output (I/O) ports 18, input/output components 20, and an illustrative power supply 22. Bus 10 represents what may be one or more buses (such as an address bus, data bus, or combination thereof). Although the various blocks of FIG. 10 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventor recognizes that such is the nature of the art, and reiterates that the diagram of FIG. 10 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various embodiments, the computing device 1000 represents the client device 920 and/or the server 910 of FIG. 9.

Memory 12 includes computer-storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 12 or I/O components 20. Presentation component(s) 16 present data indications to a user or other device. Exemplary presentation components include a display device, speaker, printing component, vibrating component, etc. In some embodiments, the memory includes program instructions that, when executed by one or more processors, cause the one or more processors to perform any functionality described herein, such as the processes 500, 600, 700, 800, and/or 900, or any functionality described with respect to FIGS. 1 through 9.

I/O ports 18 allow computing device 1000 to be logically coupled to other devices including I/O components 20, some of which may be built in. Illustrative components include a microphone, joystick, gamepad, satellite dish, scanner, printer, wireless device, etc. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be equipped with depth cameras, such as stereoscopic camera systems, infrared camera systems, RGB camera systems, touchscreen technology, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

As can be understood, embodiments of the present invention provide for, among other things, generating proof and attestation service notifications corresponding to a determined veracity of a claim. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub combinations are of utility and may be employed without reference to other features and sub combinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
receiving a design document;
generating a rendered image of the design document;
generating, via a machine learning model, a saliency mask by providing a representation of the rendered image as input to the machine learning model, the saliency mask indicates one or more regions of visual importance within the rendered image;
determining one or more animation parameters; and
based at least in part on the saliency mask, generating an animated output by at least applying the one or more animation parameters to the design document, the generating of the animated output transforms the design document into an animated design document.

2. The method of claim 1, wherein the one or more animation parameters include at least one of, one or more characteristics associated with the animated output or one or more animation rules that dictate how the animation output should be applied to different elements within a design document.

3. The method of claim 1, wherein the generation of the animation output is further based on a single user input representative of a request to convert the design document into the animation output.

4. The method of claim 1, further comprising:
generating, from the design document, a scene graph that represents each element in the design document in a hierarchical structure where each node in the scene graph corresponds to an element or group of elements in the design document.

5. The method of claim 4, wherein the generation of the animation output is further based on filtering the scene graph by selecting or discarding specific elements from the scene graph based on predefined criteria.

6. The method of claim 1, further comprising:
converting the saliency mask into a binary image using a threshold value; and
combine elements of a scene graph that are within a threshold distance to each other into one or more clusters based on using the binary image, and wherein the generating of the animation output is further based on the converting and the combining.

7. The method of claim 1, wherein the generating of the saliency mask is based on training the machine learning model on a dataset of images with labeled regions of visual importance.

8. The method of claim 1, further comprising:
detecting one or more hero elements in a scene graph based analyzing overlap between one or more design elements in the scene graph and one or more regions of high saliency in the saliency mask, and wherein the generation of the animation output is further based on the detecting of the one or more hero elements.

9. The method of claim 1, further comprising:
determining animation presets that include a set of predefined animation styles that are selectable by a user, and wherein the determining of the one or more animation parameters include determining how the animation presets are applied or changed, and wherein the generating of the animation output is based on the determining how the animation presets are applied or changed.

10. A system comprising:
A memory component; and
A processing device coupled to the memory component, the processing device to perform operations comprising:
receiving an image or file that includes one or more elements;
generating a mask that indicates one or more regions of visual importance in the image or file;
based at least in part on the mask, determining one or more animation rules; and
generating an animation sequence of the one or more elements of the image or file by at least applying the one or more animation rules.

11. The system of claim 10, wherein the mask is a saliency mask, and wherein the automatic generation of the mask includes automatically generating, via a saliency model, the saliency mask, and wherein the saliency mask is a greyscale image or a heat map that indicates which pixels of the one or more regions are likely to attract human attention.

12. The system of claim 10, wherein the generation of the animation sequence is further based on a single user input representative of a request to convert the image or file into the animation sequence.

13. The system of claim 10, wherein the image is representative of a rendered document image, the rendered document image being a visual representation of a design document, the design document being the file created in graphic design or layout software, and wherein the operations further comprising:
generating, from the design document, a scene graph that represents each element in the design document in a hierarchical structure where each node in the scene graph corresponds to an element or group of elements in the design document.

14. The system of claim 13, wherein the generation of the animation sequence of the one or more elements is further based on filtering the scene graph by selecting or discarding specific elements from the scene graph based on predefined criteria.

15. The system of claim 10, wherein the operations further comprising:
converting the mask into a binary image using a threshold value; and
combine elements of a scene graph that are within a threshold distance to each other into one or more clusters based on using the binary image, and wherein the generating of the animation sequence is further based on the converting and the combining.

16. The system of claim 10, wherein the generating of the mask is based on providing a representation of the image to a machine learning model as input and training the machine learning model on a dataset of images with labeled regions of visual importance.

17. The system of claim 10, wherein the operations further comprising:
detecting one or more hero elements in a scene graph based analyzing overlap between one or more design elements in the scene graph and one or more regions of high saliency in the mask, and wherein the generation of the animation sequence is further based on the detecting of the one or more hero elements.

18. The system of claim 10, wherein the operations further comprising:
determining animation presets that include a set of predefined animation styles that are selectable by a user, and wherein the determining of the one or more animation rules include determining how the animation presets are applied or changed, and wherein the generating of the animation sequence is based on the determining how the animation presets are applied or changed.

19. A non-transitory computer-readable medium storing executable instructions, which when executed by a processing device, cause the processing device to perform operations comprising:
generating, via a machine learning model, a mask that indicates one or more portions of an image that are likely to attract human attention, the image including one or more design elements;
filtering a representation of the one or more design elements of the image based on predetermined criteria;
detecting one or more hero elements from the filtered representation of the one or more design elements based at least in part on the mask and the filtering, the one or more hero elements indicate one or more regions of visual importance; and
generating an animated output associated with the image based at least in part on the detecting of the one or more hero elements.

20. The computer-readable medium of claim 19, wherein the operations further comprising:
grouping the filtered representation of the one or more design elements into one or more clusters based for the detecting of the one or more hero elements, wherein the generating of the animated output is further based on the grouping of the filtered representation of the one or more design elements into one or more clusters.
